(19) United States
(12) Patent Application Publication
(10) Pub. No.: US 2017/0169496 A1
(43) Pub. Date: Jun. 15, 2017

(54) METHOD AND ELECTRONIC DEVICE FOR GENERATING COMMODITY QUICK RESPONSE CODE

(71) Applicants: Le Holdings (Beijing) Co., Ltd., Beijing (CN); LE SHI INTERNET INFORMATION & TECHNOLOGY CORP. BEIJING, Beijing (CN)

(72) Inventor: Liquan ZHANG, Beijing (CN)

(21) Appl. No.: 15/250,622

(22) Filed: Aug. 29, 2016

Related U.S. Application Data
(63) Continuation of application No. PCT/CN2016/088880, filed on Jul. 6, 2016.

(30) Foreign Application Priority Data
Dec. 15, 2015 (CN) 201510939508.2

(51) Int. Cl. G06Q 30/06; G06K 7/14; G06K 19/06

(52) U.S. Cl. CPC G06Q 30/0627; G06K 19/06037; G06K 7/1417

(57) ABSTRACT

Embodiments of the present disclosure provide a method and electronic device for generating a commodity quick response code. The method includes: selecting a quick response code decoder for generating a commodity quick response code; inputting a commodity name, commodity description information and a commodity picture in the quick response code decoder; and clicking a quick response code generation button on the quick response code decoder, and storing a generated commodity quick response code.

### CROSS REFERENCE TO RELATED APPLICATIONS

This present disclosure is a continuation of International Application No. PCT/CN2016/088880, filed on Jul. 6, 2016, which is based upon and claims priority to Chinese Patent Application No. 2015109395082, filed on Dec. 15, 2015, the entire contents of all of which are incorporated herein by reference.

### TECHNICAL FIELD

The disclosure relates to the field of computer information technologies, and more particularly, to a method and an electronic device for generating a commodity quick response code.

### BACKGROUND

Barcodes are graphic symbols systematically representing data by arranging varying widths of multiple black bars and white spaces in a certain encoding rule. In a one-dimensional barcode, black bars and white spaces are arranged according to different widths of a group of horizontal black bars into a series of characters formed by “0” and “1”. The binary characters are coded according to a certain rule. In a quick response code, information is stored in a two-dimensional space of a horizontal direction and a vertical direction, and according to the encoding principle, the quick response codes are categorized into a row-type quick response code and a matrix-type quick response code. The quick response code has such advantages of large information capacity, high reliability, strong confidentiality and the like. Before scanning barcodes, consumers need to firstly download corresponding scanning software. Therefore, the operations are complicated and inconvenient.

Online shopping is advantageous in information retrieve and query. Due to rapid development of networks and computers, online sale of commodities quickly develops, such that prices, parameters and styles of the online commodities may be simply, quickly and convenient checked. These characteristics are more and more apparent, such that online shopping goes faster in daily life. However, establishment and maintenance of commodity information on the websites need manpower and materials. Further, the information amount of commodities on the websites is very huge, and when such information as pictures, prices and the like of the commodities needs to be updated, all the information of the commodities needs to be updated at the background. Therefore, modification and update of the commodity information on the websites are extremely complicated, and the operations are extremely inconvenient.

### SUMMARY

The present disclosure provide a method and electronic device for exhibiting commodity information, which may implement simple and convenient generation of a commodity quick response code. In addition, by scanning the generated commodity quick response code, the commodity information may be convenient and quickly exhibited to a user such that the user selects a commodity.

The present disclosure provide a method for generating a commodity quick response code, including:

selecting a quick response code decoder for generating a commodity quick response code;

inputting a commodity name, commodity description information, a commodity picture and a uniform resource locator of a commodity link in the quick response code decoder; and

clicking a quick response code generation button on the quick response code decoder, and storing a generated commodity quick response code.

The present disclosure provide an electronic device for generating a commodity quick response code, including: at least one processor; and a memory communicably connected with the at least one processor for storing instructions executable by the at least one processor, wherein execution of the instructions by the at least one processor causes the at least one processor to:

select a quick response code decoder for generating a commodity quick response code;

input a commodity name, commodity description information and a commodity picture in the quick response code decoder; and

click a quick response code generation button on the quick response code decoder, and store a generated commodity quick response code.

An embodiment of the present disclosure provides a non-transitory computer-readable storage medium storing executable instructions that, when executed by an electronic device, cause the electronic device to: select a quick response code decoder for generating a commodity quick response code; input a commodity name, commodity description information and a commodity picture in the quick response code decoder; and click a quick response code generation button on the quick response code decoder, and store a generated commodity quick response code.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a method for generating a commodity quick response code according to an embodiment of the present disclosure;

FIG. 2 is a schematic flowchart illustrating a method for releasing commodity information according to an embodiment of the present disclosure;

FIG. 3 is a schematic structural diagram illustrating an electronic device for generating a commodity quick response code according to an embodiment of the present disclosure; and

FIG. 4 is a block diagram illustrating an electronic device according to the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

With the development of market economy and the improvement of people's living standards, people's consumption concept is increasingly improved. However, the conventional consumption manners fail to accommodate purchase demands of the consumers. Therefore, the consumers need to seek for a new marketing mode. With the rapid development of computer technologies and information technologies, quick response codes, as a new information carrier, are integrated with mobile phones, and such integrated application has been promoted to various fields of the people's life. It is desired to develop a system or method for purchasing commodities based on commodity two-dimensional codes, which provide a wholly new consumption experience for consumers, and provide a wholly new business model for commodity merchants. In shopping malls or supermarkets, consumers may acquire detailed information of a commodity by scanning a quick response code attached on the commodity by using an electronic device, and pay for the commodity to complete on-site and self-service purchase. In this way, the consumers do not need to queue for payments, thereby saving time and manpower.

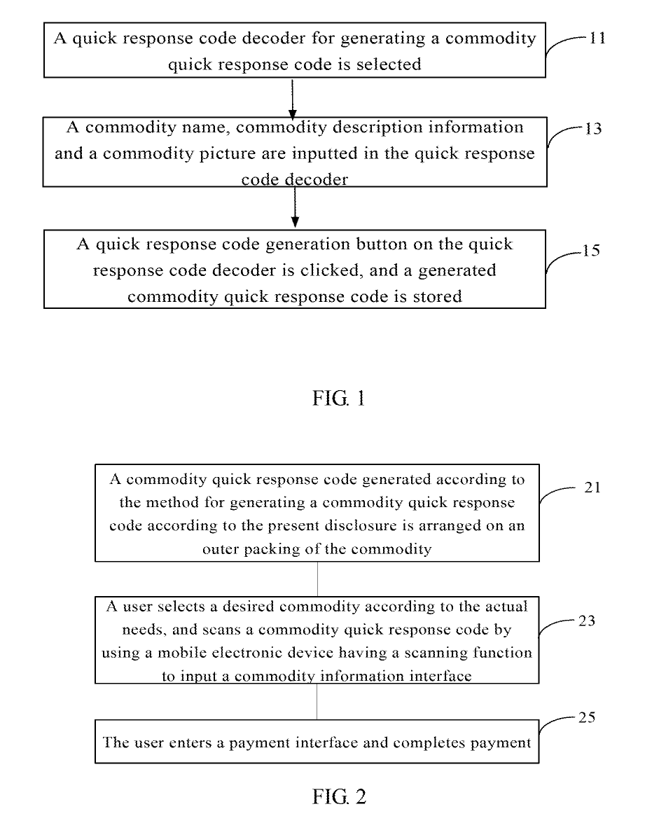

Referring to FIG. 1, a method for generating a commodity quick response code according to an embodiment of the present disclosure includes:

In step 11: a quick response code decoder for generating a commodity quick response code is selected; wherein a user, i.e., a consumer, selects, by suing an electronic device, the quick response code decoder for generating a commodity quick response code.

In step 13: a commodity name, commodity description information and a commodity picture are inputted in the quick response code decoder; wherein the user enters the commodity name, the commodity description information and the commodity picture in the quick response code decoder by using the electronic device.

In step 15: a quick response code generation button on the quick response code decoder is clicked, and a generated commodity quick response code is stored; wherein the user clicks the quick response code generation button on the quick response code decoder to generate a commodity quick response code, and the electronic device stores the generated commodity quick response code.

With the method for generating commodity information according to the embodiment the present disclosure, a quick response code decoder is selected, and a commodity name, commodity description information and a commodity picture in the quick response code decoder are inputted in the selected quick response code decoder, such that a generated commodity quick response code includes the commodity name, the commodity description information and the commodity picture. In this way, a user may directly acquire the above commodity information by scanning the quick response code, which simplifies acquisition of the commodity information for the user.

Optionally, in the technical solution disclosed in the embodiment illustrating the method for generating a commodity quick response code according to the present disclosure, the commodity description information includes one or more of price, origin and property description. In the present disclosure, content of the commodity description information is not limited, and the commodity description information may include dimensions, color, taste and the like of the commodity as long as the user find it convenient to acknowledge the commodity according to the description information.

Optionally, in the technical solution disclosed in the embodiment illustrating the method for generating a commodity quick response code according to the present disclosure, when inputting the commodity name, the commodity description information and the commodity picture in the quick response code decoder by using the electronic device, the electronic device may also enter a uniform resource locator of a commodity link in the quick response code decoder; and the method further includes: scanning, by the electronic device, the generated commodity quick response code; and opening, by the electronic device, a webpage corresponding to the website URL linking to the commodity, wherein the opened webpage displays the commodity name, the commodity description information and the commodity picture. By means of scanning the generated commodity quick response code, the user may acquire the displayed information such as the commodity name, the commodity description information and the commodity picture. Accordingly, in the technical solution disclosed in the embodiment illustrating the method for generating a commodity quick response code according to the present disclosure, acquisition of the commodity information is simple and convenient for the user.

Optionally, in the technical solution disclosed in the embodiment illustrating the method for generating a commodity quick response code according to the present disclosure, the method further includes: selecting, by the electronic device, a quantity of the commodity according to the commodity name, the commodity description information and the commodity picture, and clicking to enter a purchase and payment interface to complete payment. Nevertheless, the commodity description information may further include merchant account information corresponding to the commodity; and the payment is directly paid out to an account corresponding to the merchant account information, after the electronic device clicks the payment module to enter a purchase and payment interface to complete payment. Optionally, in the technical solution disclosed in the embodiment illustrating the method for generating a commodity quick response code according to the present disclosure, by means of scanning the generated commodity quick response code, the user may acquire the information displayed on the electronic device, and thus determine whether to buy this commodity according to the commodity information, and enter the payment interface to complete payment if it is determined to buy this commodity. That is, a purchase manner of a commodity by the user may be implemented by means of scanning the quick response code generated by using the method for generating a quick response code according to the present disclosure. The purchase manner is very simple and convenient, and thus user experience is good.

Optionally, in the technical solution disclosed in the embodiment illustrating the method for generating a commodity quick response code according to the present disclosure, the generated quick response code may be applied to a commodity; that is, the generated quick response code may be attached on an outer packing of the commodity, such that the commodity with the outer packing thereof being attached with the quick response code is placed in a storage rack in a shopping mall or supermarket for sale. Optionally, the user, i.e., the consumer may query the commodity information by scanning the quick response code attached on the outer packing of the commodity, and conduct self-service purchase. That is, the commodity quick response code generated according to the technical solution disclosed in the embodiment illustrating the method for generating a commodity quick response code according to the present disclosure may be arranged on the outer packing of the commodity for application.

The commodity quick response code generated according to the technical solution disclosed in the embodiment illustrating the method for generating a commodity quick response code according to the present disclosure may be applied on the outer packing of the commodity. The specific process of scanning or purchasing the commodity attached with a quick response code may be referenced to the descriptions in the following steps. The details may be reference to FIG. 2.

In step 21: a commodity quick response code generated according to the method for generating a commodity quick response code according to the present disclosure is arranged on an outer packing of the commodity

In step 23: a user selects a desired commodity according to the actual needs, and scans a commodity quick response code by using a mobile electronic device having a scanning function to input a commodity information interface.

In step 25: the user enters a payment interface and completes payment.

In step 21, the commodity quick response code carries account information, and during payment, a consumer is capable of directly paying money to the account opened in a bank by the merchant. In this way, convenience is brought to the consumer to purchase the commodity, and in addition, commodity promotion is achieved for the merchant.

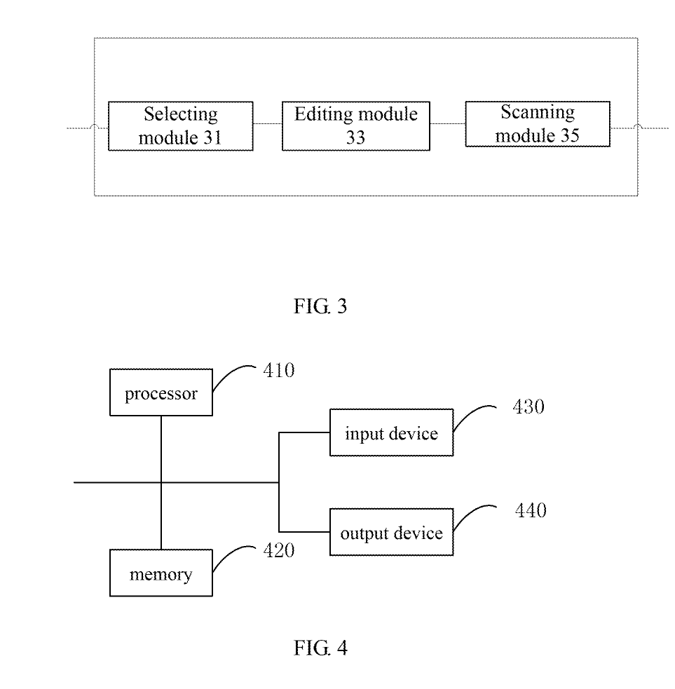

The present disclosure provide an electronic device for generating a commodity quick response code, including: a selecting module 31, an editing module 33 and a scanning module 35. A technical solution disclosed in the embodiment illustrating the electronic device for generating a commodity quick response code according to the present disclosure is described hereinafter with reference to the content in FIG. 3.

The selecting module 31 selects a quick response code decoder for generating a commodity quick response code; the editing module 33 inputs a commodity name, commodity description information and a commodity picture in the quick response code decoder; and the scanning module 35 clicks a quick response code generation button on the quick response code decoder, and store a generated commodity quick response code.

With the electronic device for generating commodity information according to the embodiment of the present disclosure, a quick response code decoder is selected by using the selecting module 31, and a commodity name, commodity description information and a commodity picture in the quick response code decoder are inputted into the selected quick response code decoder by using the editing module 33, such that a generated commodity quick response code includes the commodity name, the commodity description information and the commodity picture. In this way, a user may directly acquire the above commodity information by scanning the quick response code by using the scanning module of the electronic device, which simplifies acquisition of the commodity information for the user.

Optionally, in the technical solution disclosed in the embodiment illustrating the electronic device for generating a commodity quick response code according to the present disclosure, the commodity description information includes one or more of price, origin and property description. In the embodiment of the present disclosure, content of the commodity description information is not limited, and the commodity description information may include dimensions, color, taste and the like of the commodity as long as the user find it convenient to acknowledge the commodity according to the description information.

Optionally, in the technical solution disclosed in the embodiment illustrating the electronic device for generating a commodity quick response code according to the present disclosure, the editing module 33 is further configured to input a website URL linking to the commodity in the quick response code decoder; and the scanning module 35 opens a webpage corresponding to the website URL linking to the commodity, wherein the opened webpage displays the commodity name, the commodity description information and the commodity picture. In the technical solution disclosed in the embodiment illustrating the electronic device for generating a commodity quick response code according to the present disclosure, by means of scanning the generated commodity quick response code by using the scanning module 35, the user may acquire the displayed information such as the commodity name, the commodity description information and the commodity picture. Accordingly, in the technical solution disclosed in the embodiment illustrating the method for generating a commodity quick response code according to the present disclosure, acquisition of the commodity information is simple and convenient for the user by using the scanning module 35 of the electronic device.

Optionally, in the technical solution disclosed in the embodiment illustrating the electronic device for generating a commodity quick response code according to the present disclosure, the electronic device may further include: a payment module; and the electronic device selects a quantity of the commodity according to the commodity name, the commodity description information and the commodity picture, and clicks the payment module 37 to enter a purchase and payment interface to complete payment. Nevertheless, the commodity description information may further include merchant account information corresponding to the commodity; and the payment is directly paid out to an account corresponding to the merchant account information, after the electronic device clicks the payment module to enter a purchase and payment interface to complete payment. In the technical solution disclosed in the embodiment illustrating the method for generating a commodity quick response code according to the present disclosure, by means of scanning the generated commodity quick response code by using the scanning module, the user may acquire the information displayed on the electronic device, and thus determine whether to buy this commodity according to the commodity information, and enter the payment interface to complete payment if it is determined to buy this commodity. That is, a purchase manner of a commodity by the user may be implemented by means of scanning the quick response code generated by using the method for generating a quick response code according to the present disclosure. The purchase manner is very simple and convenient, and thus user experience is good.

With respect to the method for generating a commodity quick response code according to the embodiment of the present disclosure, a hardware processor may be used to implement related functions. The hardware processor performs the method for generating commodity quick response code according to the embodiment of the present disclosure, including the following steps:

In step 11: a quick response code decoder for generating a commodity quick response code is selected;

In step 13: a commodity name, commodity description information and a commodity picture are inputted in the quick response code decoder;

And in step 15: a quick response code generation button is clicked on the quick response code decoder the electronic device, and a generated commodity quick response code is stored.

With the method for generating commodity information according to the embodiment of the present disclosure, a quick response code decoder is selected, and a commodity name, commodity description information and a commodity picture in the quick response code decoder are inputted into the selected quick response code decoder, such that a generated commodity quick response code includes the commodity name, the commodity description information and the commodity picture. In this way, a user may directly acquire the above commodity information by scanning the quick response code, which simplifies acquisition of the commodity information for the user.

Embodiments of the present disclosure further provides a non-transitory computer-readable storage medium storing executable instructions that, when executed by an electronic device with a touch-sensitive display, cause the electronic device to perform any of the embodiments described above of the method for generating a commodity quick response code.

FIG. 4 is a schematic diagram of hardware structure of an electronic device used to perform the method for generating a commodity quick response code according to an embodiment of the present disclosure, as shown in FIG. 4, the device includes:

One or more processors 410 and a memory 420. FIG. 4 illustrates one processor 410 as an example.

The device for the method for generating a commodity quick response code may further include an input device 430 and an output device 440.

The processor 410, the memory 420, the input device 430 and the output device 440 may be connected with each other through bus or other forms of connections. FIG. 4 illustrates bus connection as an example.

As a non-volatile computer-readable storage medium, the memory 420 may be configured to store non-volatile software program, non-volatile computer executable program and modules, such as program instructions/modules corresponding to the method for generating a commodity quick response code according to the embodiments of the disclosure. By executing the non-volatile software program, instructions and modules stored in the memory 420, the processor 410 may perform various functional disclosures of the server and data processing, that is, the method for generating a commodity quick response code according to the above mentioned embodiments.

The memory 420 may include a program storage area and a data storage area, wherein, the program storage area may be stored with the operating system and disclosures which are needed by at least one functions, and the data storage area may be stored with data which is created according to use of the device for generating a commodity quick response code. Further, the memory 420 may include a high-speed random access memory, and may further include non-volatile memory, such as at least one of disk memory device, flash memory device or other types of non-volatile solid state memory device. In some embodiments, optionally, the memory 420 may include memory provided remotely from the processor 410, and such remote memory may be connected with the device for generating a commodity quick response code through network connections, the examples of the network connections may include but not limited to internet, intranet, LAN (Local Area Network), mobile communication network or combinations thereof.

The input device 430 may receive inputted number or character information, and generate key signal input related to the user settings and functional control of the device for generating a commodity quick response code. The output device 440 may include a display device such as a display screen.

The above one or more modules may be stored in the memory 420, when these modules are executed by the one or more processors 410, the method for generating a commodity quick response code according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above described apparatus embodiments are merely for illustration purpose only. The modules which are described as separate components may be physically separated or may be not physically separated, and the components which are illustrated as modules may be or may not be physical modules, that is, the components may be located in the same position or may be distributed into a plurality of network modules. A part or all of the modules may be selected according to the actual needs to achieve the objectives of the technical solutions of the embodiments. Persons of ordinary skill in the art may understand and implement the present disclosure without paying any creative effort.

According to the above embodiments of the present disclosure, a person skilled in the art may clearly understand that the embodiments of the present disclosure may be implemented by means of hardware or by means of software plus a necessary general hardware platform. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (a personal computer, a server, or a network device) to perform the various embodiments of the present disclosure, or certain portions of the method of the embodiments.

It should be finally noted that the above-described embodiments are merely for illustration of the present disclosure, but are not intended to limit the present disclosure. Although the present disclosure is described in detail with reference to these embodiments, a person skilled in the art may also make various modifications to the technical solutions disclosed in the embodiments, or make equivalent replacements to a part of the technical features contained therein. Such modifications or replacement, made without departing from the principles of the present disclosure, shall fall within the scope of the present disclosure.

What is claimed is:

1. A method for generating a commodity quick response code, comprising at an electronic device:
selecting a quick response code decoder for generating a commodity quick response code;
inputting a commodity name, commodity description information and a commodity picture in the quick response code decoder; and
clicking a quick response code generation button on the quick response code decoder, and storing a generated commodity quick response code.

2. The method according to claim 1, wherein
the commodity description information comprises one or more of price, origin and property description.

3. The method according to claim 1, further comprising:
inputting a website URL linking to the commodity in the quick response code decoder;
scanning the generated commodity quick response code; and
opening a webpage corresponding to the website URL linking to the commodity, wherein the opened webpage displays the commodity name, the commodity description information and the commodity picture.

4. The method according to claim 3, further comprising: selecting, by the electronic device, a quantity of the commodity according to the commodity name, the commodity description information and the commodity picture, and clicking to enter a purchase and payment interface to complete payment.

5. The method according to claim 4, wherein, the commodity description information further comprises: merchant account information corresponding to the commodity; and
the payment is directly paid out to an account corresponding to the merchant account information, after the clicking to enter a purchase and payment interface to complete payment.

6. An electronic device, comprising:
at least one processor; and
a memory communicably connected with the at least one processor for storing instructions executable by the at least one processor, wherein execution of the instructions by the at least one processor causes the at least one processor to:
select a quick response code decoder for generating a commodity quick response code;
input a commodity name, commodity description information and a commodity picture in the quick response code decoder; and
click a quick response code generation button on the quick response code decoder, and store a generated commodity quick response code.

7. The electronic device according to claim 6, wherein,
the commodity description information comprises one or more of price, origin and property description.

8. The electronic device according to claim 6, wherein, the at least one processor is further caused to: input a website URL linking to the commodity in the quick response code decoder; and
open a webpage corresponding to the website URL linking to the commodity, wherein the opened webpage displays the commodity name, the commodity description information and the commodity picture.

9. The electronic device according to claim 8, wherein, the at least one processor is further caused to:
select a quantity of the commodity according to the commodity name, the commodity description information and the commodity picture, and click to enter a purchase and payment interface to complete payment.

10. The electronic device according to claim 9, wherein
the commodity description information further comprises: merchant account information corresponding to the commodity; and
the payment is directly paid out to an account corresponding to the merchant account information, after the clicking to enter a purchase and payment interface to complete payment.

11. A non-transitory computer-readable storage medium storing executable instructions that, when executed by an electronic device, cause the electronic device to:
select a quick response code decoder for generating a commodity quick response code;
input a commodity name, commodity description information and a commodity picture in the quick response code decoder; and
click a quick response code generation button on the quick response code decoder, and storing a generated commodity quick response code.

12. The non-transitory computer-readable storage medium according to claim 11, wherein the commodity description information comprises one or more of price, origin and property description.

13. The non-transitory computer-readable storage medium according to claim 11, the electronic device is further caused to:
input a website URL linking to the commodity in the quick response code decoder;
scan the generated commodity quick response code; and
open a webpage corresponding to the website URL linking to the commodity, wherein the opened webpage displays the commodity name, the commodity description information and the commodity picture.

14. The non-transitory computer-readable storage medium according to claim 13, the electronic device is further caused to:
select, by the electronic device, a quantity of the commodity according to the commodity name, the commodity description information and the commodity picture, and click to enter a purchase and payment interface to complete payment.

15. The non-transitory computer-readable storage medium according to claim 14, wherein, the commodity description information further comprises: merchant account information corresponding to the commodity; and
the payment is directly paid out to an account corresponding to the merchant account information, after the clicking to enter a purchase and payment interface to complete payment.
